(19) United States
(12) Patent Application Publication
(10) Pub. No.: US 2004/0166221 A1
(43) Pub. Date: Aug. 26, 2004

(54) Gummi candy and production thereof

(75) Inventor: Juzo Hashimoto, Osaka-shi (JP)

Correspondence Address: MERCHANT & GOULD PC, P.O. BOX 2903, MINNEAPOLIS, MN, 55402-0903, US

(73) Assignee: Morishita Jintan Co., Ltd., Osaka-shi (JP)

(21) Appl. No.: 10/374,308

(22) Filed: Feb. 25, 2003

(51) Int. Cl. A23L 1/05

(52) U.S. Cl. 426/573

(57) ABSTRACT

Disclosed is a gummi candy which comprises a gummi material and granules adhered on the gummi material by function of transglutaminase, and a production thereof.

### FIELD OF THE INVENTION

The present invention relates to a gummi candy having granules adhering thereon using an enzyme and a production thereof.

### BACKGROUD OF THE INVENTION

A gummi candy is generally a type of jellies that is produced by shaping powdered sugar or liquid sugar and gelatin. It has high sugar content, rich elasticity and peculiar chewy feeling. The gummi candies usually have coatings of vegetable oil or powdered sugar (anti-stick agent) on the surfaces, because gelatin of the gummi candies begins to melt from its surface at an ambient temperature of about 38° C. or more and the gummi candies easily adhere with each other.

According to a conventional method, for example, a gummi candy having powder coating is obtained by spraying steam against a surface of a shaped gummi material to melt it slightly, and covering with the releasing agent, followed by drying. However, the coatings on the surface of the gummi candies give rise to some defects, because modification of gelatin and sugar generates due to change of temperature or humidity in surroundings. Therefore, the purpose of preventing adhesion between gummi candies cannot be achieved and commercial value of the gummi candy decreases.

### OBJECT OF THE INVENTION

An object of the present invention is to provide with a method for producing a gummi candy having releasing coatings that are tightly fixed on the surface without depending on change of temperature and humidity conditions.

### SUMMARY OF THE INVENTION

It is well known that transglutaminase is applied on protein in food materials to catalyze a cross-linking reaction of glutamine residues with lysine residues in the protein molecules to gel (Japanese Patent Publication (examined)Hei 1(1989)-50,382). The resulting gelled product has advantages that it can be produced without heating and has excellent thermal stability. It has then been discovered that transglutaminase is applied to a surface of a gelatin-containing gummi candy, to which granules are adhered, and a gelled layer is formed on the surface of the gummi candy to enhance bonding strength of the granules to the gummi candy. As the gelled layer does not change easily due to change of temperature or humidity, it is considered that stability of the gummi candy itself as product can be improved and the present invention was thus completed.

That is, the present invention is a method for producing a gummi candy comprising steps of shaping a gummi material containing a sugar component and a gelling agent, applying transglutaminase to a surface of the gummi material, and then adhering granules to the surface. The gummi candy produced according to the method of the present invention has improved heat resistance and moisture resistance and a feature that the granules do not easily peel off from the surface of the gummi candy by friction effect.

### BRIEF DESCRIPTION OF THE DRAWINGS

FIG. 1 shows a schematic view containing a cross sectional view of a gummi candy produced by the method of the present invention.

FIG. 2 shows a relationship between density of transglutaminase in the used paste and amount of granules peeling off by friction treatment (amount of abrasion; %) in the gummi candy produced in Example according to the present invention.

### DETAILED DESCRIPTION OF THE INVENTION

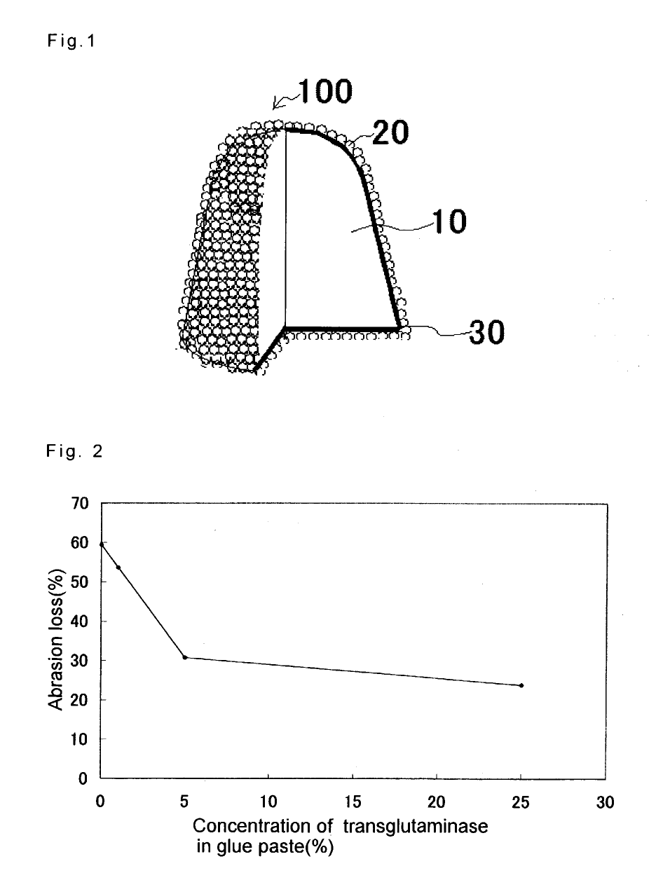

An example of the gummi candy 100 obtained according to the present invention is shown in FIG. 1. The gummi candy 100 is obtained by applying transglutaminase to a surface of the gummi material 10 and then adhering the granules 20 to the surface.

The gummi material to which the granules are adhered mainly contains sugar component and a gelling agent and is formed by gelling the sugar component and the gelling agent and then shaping.

The sugar component is selected from sugar alcohols, such as sucorose, maltose, glucose, glucose syrup, sorbitol and the like. The gummi candy preferably may have a sugar density of 30 to 80%.

The gelling agent includes an animal-deriving protein, such as gelatin; a vegetable-deriving polysaccharide, such as agar, carrageenan, furcellaran, alginic acid, cyamoposis gum, locust bean gum, tamarind gum, arabian gum, arabinogalactan, tragacanth gum, pectin and the like; and bacteria-deriving polysaccharide, such as pullulan, xanthan gum, dextran and the like, but preferred are gelatin and pectin.

The more suitable gummi material used in the present invention contains 50 to 95 weights % of saccharide as the sugar component, 3 to 10 weights % of gelatin and 1 to 5 weights % of pectin as the gelling agent and 1 to 20 weights % of desired additives (for example, food organic acids, such as citric acid, malic acid and the like, various fruit juices, edible food color, sweetening agent, various vitamins, food flavors and the like), based on a total weights of a composition of the gummi material. The gummi material is shaped by conventional process using the above composition, for example, to obtain a suitable moisture content of 15 to 25 weights %.

Then, transglutaminase is applied on a surface of the shaped gummi material, to which the granules 20 are adhered. It is considered that the transglutaminase catalyzes a cross-linking reaction of glutamine residues with lysine residues in gelatin that is present in the surface of the gummi material, to form, a gelled layer 30 on the surface of the gummi material 10, which enhances adhesive property of the granules 20 to the surface as shown in FIG. 1. It is also considered that, when gelatin capsules explained later are used as the granule, the transglutaminase catalyzes a cross-linking reaction of glutamine residues with lysine residues of the gelatin capsule in a similar way with the gummi material so as to make a bond between the gummi material and the gelatin capsule stronger.

The present invention can provide the gummi candy with improved surface properties without heating, i.e. without melting the surface of the gummi material by steam in a conventional process. The gummi candy also enhances thermal resistance. and moisture resistance by the presence of the gelled layer.

The transglutaminase may be any one that derives from animals, plants or bacteria. Preferred is one that derives from bacteria, such as Active TG-S available from Ajinomoto Co. Ltd.

The transglutaminase can be applied to a whole or a part of the surface of the gummi material. Application of the transglutaminase is not limited to a specific method, but it is conducted, for example, by dissolving or dispersing the transglutaminase in a solvent that acts as give, such as liquid sugar, aqueous solution saturated with sugar, starch solution or gum solution, such as Arabian gum solution, into which the gummi material is immersed. In this case, the transglutaminase may have a density of about 25 to 1 weights % in the give paste based on total weights thereof.

After acting the transglutaminase on the surface of the gummi material as mentioned above, the granules are applied thereto to adhere to the surface of the gummi material. Preferably, the granules are adhered before the give paste containing transglutaminase dissolved dries and cures on the surface of the gummi material. The granules to be used can prevent the gummi candies from adhering each other and can give the gummi candy variety of appearance and taste by flavor that is contained in the granules. Examples of the applicative granules include natural granules, such as broiled grains of poppy seed, sesame and the like; small sugar-coating products that are formed by coating a globular granule core agent having high sphericity with functional food material (for example, Nonparel® available from Froint Industrial Co. Ltd.); gelatin capsules and the like. The gelatin capsule is not limited specially as long as it contains a content in a shell formed from gelatin and the content is harmless to a human body. Examples of the contents of the gelatin capsule include vitamin E, vitamin A, DHA, EPA and other functional oils.

The size of the granule is not limited as long as it gives the gummi candy desired flavor and design, but it is preferred that, the granule has a particle size of about 0.5 to 3 mm.

More preferably, the granules can be globular gelatin capsules available from Morishita Jintan Co. Ltd., which have a particle size of 1.5 mm and contain vitamin A or vitamin E as the content.

When the natural granules are used, they are preferably dried by hot air drying method or the like before applying. Then, the gummi material on which transglutaminase acts is put into the granules to adhere tightly the granules to the surface of the gummi material.

An adhesion amount of the granules to the gummi material may change depending on shape and size of the gummi candy, size of the granule, adhesion form (overall adhesion or partial adhesion) and the like. For example, when the gelatin capsules having a diameter of about 1.5 mm are adhered to the gummi candy having a form as shown in FIG. 1 (bottom diameter×height; about 1 cm×1.5 cm), the gelatin capsule can adhere at a percentage of about 29 to 19% based on total surface area of the gummi material.

### EXAMPLES

The method for producing the gummi candy of the present invention is further explained in detail with reference to the following examples, but the following examples are used for illustration purpose and are not construed as limiting the invention thereto.

The following formulation was used to shape gummi materials having a shape as shown in FIG. 1.

TABLE 1

| Formulation of gummi | |
|---|---|
| material | Formulating amount (g) |
| Sugar component: | |
| Granulated sugar | 40.0 |
| 75% glucose syrup | 45.4 |
| 70% sorbitol solution | 6.0 |
| Gelatin | 8.0 |
| Pectin | 0.2 |
| Flavor | 0.4 |

Then, four types of transglutaminase give paste containing were preparated by adding transglutaminase (Activa Series TG-S available from Ajinomoto Co. Ltd.) to liquid sugar having a sugar density of about 60% so as to adjust densities of 0, 1, 5 and 25 weights % based on total weights of the liquid sugar, respectively.

Separately, granules (gelatin capsules containing vitamin E and available from Morisita Jintan Co. Ltd., and having a diameter of about 1.5 mm) were put in a revolving-pan and dried by dry air with revolving.

The above gummi materials were immersed in each paste of the above density and taken out. While the surfaces of the gummi materials were wet with the paste, the gummi materials were put into the revolving-pan to adhere the granules thereto. After the granules were adhered uniformly on the surfaces of the gummi materials, the gummi materials were spooned up by a rough sieve and placed on a trey having vent holes, to dry at a temperature of 20 to 30° C., thus obtaining gummi candies. A weight of the gummi materials before the granules adhesion treatment and a weight of the gummi candies after granules adhesion were measured and percentage of adhesion of granules was calculated according to the following formula. The results were shown in Table 2.

$$\begin{matrix}Percentage of \\ granule \\ adhesion ( \% )\end{matrix} = \frac{( \begin{matrix}Weight of the gummi \\ candies after glanule - \\ Weight of gummi materials \\ before granule adhesion\end{matrix} )}{\begin{matrix}Weight of gummi materials \\ before granule adhesion\end{matrix}} \times 100 \qquad Formula 1$$

TABLE 2

Weight (g)

| Before | After | | Percentage |
|---|---|---|---|
| adhesion | adhesion | Density of | of granule |
| (gummi | (gummi | transglutaminase | adhesion |
| materials) | candies) | (Weight %) | (%) |
| 24.9 | 31.85 | 25 | 21.82 |
| 24.95 | 32.33 | 5 | 22.83 |
| 25.45 | 31.62 | 1 | 19.51 |
| 24.7 | 30.67 | 0 | 19.47 |

It can be understood that use of the give paste dissolving transglutaminase allows more granules to adhere to the surface of the gummi candy.

The above resulting gummi candies were evaluated by amount of abrasion loss using the following procedure.

The above resulting gummi candies were subjected to abrasion treatment using a TFT-120 type rotating drum abrasion loss test equipment available from TOYAMA SANGYO Co., Ltd.. The amount of abrasion loss (%) was defined as an amount of granules dropping out from the gummi candies, which was obtained from a difference between a weight of gummi candies before abrasion treatment and a weight of the same after abrasion treatment. The results were shown in Table 3. Additionally, a relationship between the density of the transglutaminase in the used glue paste and the amount of abrasion loss was shown in a graph of FIG. 2.

TABLE 3

| | Weight of | |
|---|---|---|
| Density of | gummi candies (g) | Amount of |

| transglutaminase(%) | Before test | After test | abrasion (%) |
|---|---|---|---|
| 25 | 31.85 | 30.19 | 23.9 |
| 5 | 32.33 | 30.06 | 30.8 |
| 1 | 31.62 | 28.33 | 53.3 |
| 0 | 30.67 | 27.12 | 59.5 |

It is understood from the above results that increase of the density of the transglutaminase in the glue paste leads to decrease of the amount of abrasion loss of the granules from the gummi candy.

The gummi candy obtained according to the method of production of the present invention has good thermal resistance and moisture resistance and the granules do not drop off from the surface of the gummi candy easily by abrasion effect because the granules are tightly fixed to the surface of the gummi candy.

What is claimed is

1. A method for producing a gummi candy comprising steps of;
shaping a gummi material containing a sugar component and a gelling agent,
applying transglutaminase to a surface of said gummi material, and
adhering granules to the surface.

2. The method for producing the gummi candy according to claim 1 wherein said gelling agent is gelatin and pectin.

3. The method for producing the gummi candy having the granules that are adhered to the surface according to claim 1 wherein the transglutaminase is dissolved in a glue paste, which is applied to the surface of the gummi material.

4. The method for producing the gummi candy according to claim 1 wherein the granules are globular gelatin capsules.

5. A gummi candy comprising a gummi material and granules adhered on the gummi material by function of transglutaminase.

6. The gummi candy according to claim 5 wherein the granules are globular gelatin capsules.
